(19) United States
(12) Patent Application Publication
(10) Pub. No.: US 2014/0376891 A1
(43) Pub. Date: Dec. 25, 2014

(54) SYSTEM FOR PROVIDING AN ENVIRONMENT IN WHICH PERFORMERS GENERATE CORRESPONDING PERFORMANCES

(71) Applicant: GodleyWood Limited, Dublin (IE)

(72) Inventors: Donal Gaffney, Dublin (IE); Kevin Godely, Co Wicklow (IE); John Holland, Dublin (IE); Richard Hurford, Cardiff (GB); Brendan Phelan, Co Dublin (IE)

(73) Assignee: GodleyWood Limited, Dublin (IE)

(21) Appl. No.: 13/926,293

(22) Filed: Jun. 25, 2013

(30) Foreign Application Priority Data
Jun. 25, 2013 (GB) 1311240.4

(51) Int. Cl. G11B 27/10; H04N 9/79

(52) U.S. Cl. CPC G11B 27/10; H04N 9/79
USPC 386/337

(57) ABSTRACT

A system for providing an environment in which one or more performers are able to generate one or more corresponding performances which are mutually synchronized is provided. The system includes a server arrangement coupled via one or more communication networks to one or more computing devices of the performers. A given computing device is operable to receive one or more pre-recorded sessions from the server arrangement. The given computing device is then operable to replay the pre-recorded sessions whilst substantially temporally simultaneously recording an accompanying performance by at least one performer associated with the given computing device. Further, the system is operable to render at least one pre-recorded session and the accompanying performance mutually synchronized therewith.

### TECHNICAL FIELD

The present disclosure generally relates to systems for providing an environment for generation of audio-visual content.

### BACKGROUND

Today, music videos are prevalent everywhere. More and more new music videos are being created by musicians and professional artists to provide a visually and acoustically appealing performance to their fans. New musicians are emerging every day. Still, many of these new musicians are unable to showcase their talent, due to lack of an easily available and easy-to-use music video platform. Moreover, musicians located in faraway places are often unable to collaborate cost effectively with other musicians.

Conventional techniques for providing a music video platform exist. One conventional technique allows users to record their performance and upload their performance on video-sharing websites. Another conventional technique allows a user to create a new music video by intercutting user-supplied images and/or videos at selected temporal sections of a pre-existing music video. Yet another conventional technique employs manual offline editing software to synchronise and render multiple music videos together. Still another convention technique allows users to record audio clips of their performances and to synchronize and combine the audio clips together.

However, these conventional techniques suffer from several disadvantages. Firstly, other users are not allowed to add to performances shared on video-sharing websites. Secondly, users are not allowed to modify or make additions to audio content of pre-existing music videos. Thirdly, manual synchronization is time-consuming and expensive. Fourthly, manual synchronization is not suitable for amateurs and non-technical users. Fifthly, some conventional techniques allow synchronization of only audio clips.

Therefore, there exists a need for a system for providing an environment in which one or more performers are able to generate one or more corresponding performances which are mutually synchronized in an automatic manner.

### SUMMARY

The present disclosure seeks to provide a system for providing an environment in which one or more performers are able to generate one or more corresponding performances which are mutually synchronized.

The present disclosure also seeks to provide a method of using the system thereof.

In one aspect, embodiments of the present disclosure provide a system for providing an environment in which one or more performers are able to generate one or more corresponding performances which are mutually synchronized irrespective of location globally. The system includes a server arrangement coupled via one or more communication networks to one or more computing devices of the performers.

Optionally, the server arrangement may be implemented, at least in part, in the computing devices. Alternatively, the server arrangement may be implemented spatially remotely from the computing devices.

A given computing device is operable to receive one or more pre-recorded sessions from the server arrangement. The given computing device is then operable to replay the pre-recorded sessions whilst substantially temporally simultaneously recording an accompanying performance by at least one performer associated with the given computing device.

In addition, the substantially temporally simultaneous recording of the accompanying performance may employ at least one microphone and/or at least one camera of the given computing device for sensing the accompanying performance.

In accordance with an embodiment of the present disclosure, the pre-recorded sessions are stored locally, for example, in data memory or an internal storage of the given computing device, and the replaying of the pre-recorded sessions is thereafter implemented during the recording of the accompanying performance by accessing the pre-recorded sessions stored locally on the given computing device.

In accordance with another embodiment of the present disclosure, the pre-recorded sessions are streamed and replayed in real-time by the given computing device during the recording of the accompanying performance.

Moreover, the system is operable to render at least one pre-recorded session from the pre-recorded sessions and the accompanying performance mutually synchronized therewith. Beneficially, the system may be operable to render the at least one pre-recorded session and the accompanying performance as a mosaic of images and/or videos on a Graphical User Interface (GUI) presented on one or more display screens of the given computing device.

Additionally, the mosaic of images and/or videos may be rendered in a predefined format. The predefined format may, for example, depend on a number of the at least one pre-recorded session and the accompanying performance to be rendered, a type of the given computing device, and/or one or more preferences of the at least one performer associated with the given computing device.

In addition, the system may be operable to provide for mutual temporal synchronization of the accompanying performance with the at least one pre-recorded session. Optionally, the system may be operable to render the at least one pre-recorded session and the accompanying performance whilst substantially simultaneously providing for the mutual temporal synchronization of the accompanying performance with the at least one pre-recorded session.

The mutual temporal synchronization may be implemented by at least one of:

(i) a tool of the given computing device which allows for manual adjustment of relative rendering time of the at least one pre-recorded session with the accompanying performance; and/or
(ii) a tool of the given computing device and/or the server arrangement which automatically adjusts the mutual temporal synchronization depending upon information included in the at least one pre-recorded session and/or the accompanying performance, and/or a communication characteristic of the communication networks coupling the given computing device to the server arrangement.

Moreover, the system may be operable to enable the at least one performer to upload their recorded accompanying performance to the server arrangement for subsequent distribution to other computing devices. The recorded accompanying performance may be uploaded, for example, in a form of a composite session that includes the recorded accompanying performance substantially temporally synchronized with at least one of the pre-recorded sessions.

Moreover, the system may be operable to provide for generation of audio-visual content for distribution via the server arrangement.

Furthermore, receiving of the pre-recorded sessions from the server arrangement, and/or subsequent distribution of one or more sessions including the accompanying performance may be subject to financial payment to at least one of: the at least one performer associated with the accompanying performance, and/or one or more performers responsible for creating the pre-recorded sessions.

In another aspect, embodiments of the present disclosure provide a method of using the system for providing the environment in which the performers are able to generate the corresponding performances which are mutually synchronized irrespective of location globally.

In yet another aspect, embodiments of the present disclosure provide a software product recorded on non-transitory machine-readable data storage media, wherein the software product is executable upon computing hardware for implementing the aforementioned method.

Embodiments of the present disclosure substantially eliminate the aforementioned problems in the prior art, and enable users to generate a single composite session from one or more pre-recorded sessions and one or more accompanying performances created separated in distance and time, and to render the composite session as a mosaic of images and/or videos; there is facilitated automatic synchronization of the pre-recorded sessions and the accompanying performances, thereby enabling amateurs and non-technical users to generate easily audio-visual content; moreover, embodiments of the present disclosure enable performers to interact and collaborate cost effectively with other performers and users, and to monetize their performances.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a system for providing an environment in which one or more performers are able to generate one or more corresponding performances which are mutually synchronized irrespective of location globally, in accordance with an embodiment of the present disclosure;

FIG. 2 is a schematic illustration of various components in an example implementation of a given computing device, in accordance with an embodiment of the present disclosure;

FIG. 3 is an illustration of a mutual temporal synchronization in a first example scenario, in accordance with an embodiment of the present disclosure;

FIG. 4 is an illustration of the mutual temporal synchronization in a second example scenario, in accordance with an embodiment of the present disclosure;

FIG. 5 is an illustration of steps of a method of using the system to provide the environment in which the performers are able to generate the corresponding performances which are mutually synchronized irrespective of location globally, in accordance with an embodiment of the present disclosure; and

FIGS. 6A and 6B are illustrations of steps of a detailed method of using the system to provide the environment in which the performers are able to generate the corresponding performances which are mutually synchronized irrespective of location globally, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF ILLUSTRATIVE EMBODIMENTS

The following detailed description illustrates embodiments of the present disclosure and ways in which it can be implemented. Although the best mode of carrying out the present disclosure has been disclosed, those in the art would recognize that other embodiments for carrying out or practicing the present disclosure are also possible.

Embodiments of the present disclosure provide a system for providing an environment in which one or more performers are able to generate one or more corresponding performances which are mutually synchronized irrespective of location globally. The system includes a server arrangement coupled via one or more communication networks to one or more computing devices of the performers.

Optionally, the server arrangement may be implemented, at least in part, in the computing devices. Alternatively, the server arrangement may be implemented spatially remotely from the computing devices.

A given computing device is operable to receive one or more pre-recorded sessions from the server arrangement. The given computing device is then operable to replay the pre-recorded sessions whilst substantially temporally simultaneously recording an accompanying performance by at least one performer associated with the given computing device.

The term ‘replay’ may refer to acoustic and/or visual replay of the pre-recorded sessions. The pre-recorded sessions may be replayed, for example, to help the at least one performer to perform the accompanying performance substantially in sync with the pre-recorded sessions.

In addition, the substantially temporally simultaneous recording of the accompanying performance may employ at least one microphone and/or at least one camera of the given computing device for sensing the accompanying performance.

In accordance with an embodiment of the present disclosure, the pre-recorded sessions are stored locally, for example, in data memory or an internal storage of the given computing device, and the replaying of the pre-recorded sessions is thereafter implemented during the recording of the accompanying performance by accessing the pre-recorded sessions stored locally on the given computing device.

In accordance with another embodiment of the present disclosure, the pre-recorded sessions are streamed and replayed in real-time by the given computing device during the recording of the accompanying performance. Optionally, to least a portion of the accompanying performance may be streamed in real-time back to the server arrangement during the recording thereof.

Moreover, the system is operable to render at least one pre-recorded session from the pre-recorded sessions and the accompanying performance mutually synchronized therewith. Beneficially, the system may be operable to render the at least one pre-recorded session and the accompanying performance as a mosaic of images and/or videos on a Graphical User Interface (GUI) presented on one or more display screens of the given computing device.

Moreover, the mosaic of images and/or videos may be rendered manually or automatically in a predefined format. The predefined format may depend on, for example, a number of the at least one pre-recorded session and the accompanying performance to be rendered, a type of the given computing device, and/or one or more preferences of the at least one performer associated with the given computing device.

In addition, the system may be operable to provide for mutual temporal synchronization of the accompanying performance with the at least one pre-recorded session. Optionally, the system may be operable to render the at least one pre-recorded session and the accompanying performance whilst substantially simultaneously providing for the mutual temporal synchronization of the accompanying performance with the at least one pre-recorded session.

The mutual temporal synchronization may be implemented by at least one of:

(i) a tool of the given computing device which allows for manual adjustment of relative rendering time of the at least one pre-recorded session with the accompanying performance; and/or
(ii) a tool of the given computing device and/or the server arrangement which automatically adjusts the mutual temporal synchronization depending upon information included in the at least one pre-recorded session and/or the accompanying performance, and/or a communication characteristic of the communication networks coupling the given computing device to the server arrangement.

Moreover, the system may be operable to enable the at least one performer to upload their recorded accompanying performance to the server arrangement for subsequent distribution to other computing devices. The recorded accompanying performance may be uploaded, for example, in a form of a composite session that includes the recorded accompanying performance substantially temporally synchronized with at least one of the pre-recorded sessions.

Moreover, the system may be operable to provide for generation of audio-visual content for distribution via the server arrangement.

Furthermore, receiving of the pre-recorded sessions from the server arrangement, and/or subsequent distribution of one or more sessions including the accompanying performance may be subject to financial payment to at least one of: the at least one performer associated with the accompanying performance, and/or one or more performers responsible for creating the pre-recorded sessions.

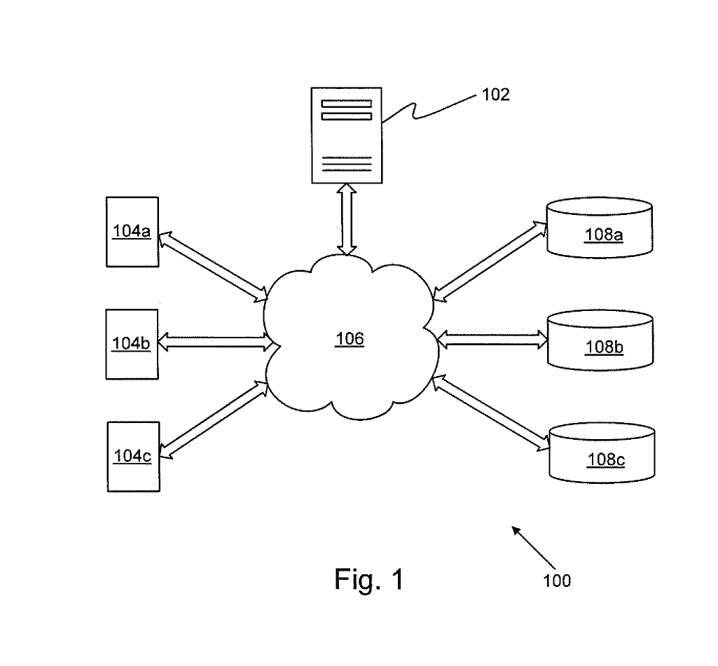

Referring now to the drawings, particularly by their reference numbers, FIG. 1 is a schematic illustration of a system 100 for providing an environment in which one or more performers are able to generate one or more corresponding performances which are mutually synchronized irrespective of location globally, in accordance with an embodiment of the present disclosure. The system 100 includes a server arrangement 102 and one or more computing devices of the performers, depicted as a computing device 104a, a computing device 104b and a computing device 104c in FIG. 1 (hereinafter collectively referred to as computing devices 104). The system 100 also includes one or more communication networks, depicted as a communication network 106 in FIG. 1. In addition, the system 100 includes one or more databases, depicted as a database 108a, a database 108b and a database 108c in FIG. 1 (hereinafter collectively referred to as databases 108). The databases 108 may, for example, be associated with the server arrangement 102.

The server arrangement 102 and the computing devices 104 may be distributed geographically. In one example, the server arrangement 102 may be implemented spatially remotely from the computing devices 104. Beneficially, the server arrangement 102 may be implemented as a cloud service.

In another example, the server arrangement 102 may be implemented, at least in part, in the computing devices 104. In such a case, the system 100 may be implemented in a peer-to-peer (P2P) network in which various functionalities of the server arrangement 102 may be distributed between the computing devices 104.

The communication network 106 couples the server arrangement 102 to the computing devices 104, and provides a communication medium between the server arrangement 102 and the computing devices 104 for exchanging data amongst themselves. It may be noted here that the computing devices 104 may not be temporally simultaneously coupled to the server arrangement 102, but be coupled to the server arrangement 102 separated in times.

The communication network 106 can be a collection of individual networks, interconnected with each other and functioning as a single large network. Such individual networks may be wired, wireless, or a combination thereof. Examples of such individual networks include, but are not limited to, Local Area Networks (LANs), Wide Area Networks (WANs), Metropolitan Area Networks (MANs), Wireless LANs (WLANs), Wireless WANs (WWANs), and Wireless MANs (WMANs).

Examples of the computing devices 104 include, but are not limited to, mobile phones, smart phones, Mobile Internet Devices (MIDs), tablet computers, Ultra-Mobile Personal Computers (UMPCs), phablets, Personal Digital Assistants (PDAs), web pads, Personal Computers (PCs), handheld PCs, laptop computers, and interactive entertainment computers.

Optionally, the server arrangement 102 may include one or more servers (not shown in FIG. 1), and a load balancer (not shown in FIG. 1) to balance communication load on these servers. Beneficially, each of these servers may be coupled to the databases 108 via the communication network 106.

Moreover, one or more of the databases 108 may be used to store one or more pre-recorded sessions. The pre-recorded sessions may be in a form of multimedia content, which may include one or more audio clips, one or more still images, one or more animations, one or more video clips, or a combination thereof. For example, a pre-recorded session may include multiple audio clips and/or video clips that may have been previously synchronised together as a single session.

Accordingly, one or more of the databases 108 may be implemented as Binary Large OBject (BLOB) databases that may store multimedia content, such as audio, video and images. Beneficially, the databases 108 may be implemented as cloud databases.

The server arrangement 102 enables the computing devices 104 to access the pre-recorded sessions stored in the databases 108. Accordingly, the server arrangement 102 may allow the performers to download one or more of the pre-recorded sessions and/or upload one or more new sessions to the databases 108.

Beneficially, the performers may access various services provides by the server arrangement using a secure connection.

In order to manage the use and distribution of the pre-recorded sessions, one or more performers responsible for creating the pre-recorded sessions may provide information including at least one of: who may be allowed to use their pre-recorded sessions, territories and/or countries where their pre-recorded sessions may be used and/or distributed, how their pre-recorded sessions may be used, a number of times their pre-recorded sessions may be used, a time period for which their pre-recorded sessions may be used, an amount that may be charged for use of their pre-recorded sessions, one or more modes in which the amount may be paid, and/or how the amount may be shared amongst the performers. The information provided by the performers may be stored in at least one of the databases 108.

In accordance with a specific embodiment of the present disclosure, the pre-recorded sessions are encrypted to prevent extraction of the pre-recorded sessions for unauthorized dissemination. Accordingly, a given computing device may be provided with a time-limited decryption key, along with the encrypted pre-recorded sessions from the server arrangement 102. The time-limited decryption key may, for example, be linked to an Internet-available time clock, and may be used to decrypt and use the pre-recorded sessions for a limited time period.

In order to illustrate the implementation of the system 100, let us consider an example scenario in which the computing device 104a is associated with a first performer, the computing device 104b is associated with a second performer and a third performer, and the computing device 104c is associated with a fourth performer. Let us consider that the first performer associated with the computing device 104a wishes to create an accompanying performance for a particular song.

The first performer may browse through and/or search for one or more pre-recorded sessions related to that particular song available via the server arrangement 102. The first performer may then select one or more of the pre-recorded sessions related to that particular song to be downloaded on the computing device 104a. The first performer may browse and/or search and/or select the pre-recorded sessions, for example, using a GUI presented on one or more display screens of the computing device 104a.

Consequently, the computing device 104a receives the pre-recorded sessions selected by the first performer from the server arrangement 102.

Optionally, receiving of the pre-recorded sessions from the server arrangement 102 may be subject to financial payment to one or more performers responsible for creating the pre-recorded sessions. For this purpose, the first performer may have a pre-paid account from which the financial payment may be made, for example, to one or more pre-paid accounts of the performers responsible for creating the pre-recorded sessions. Accordingly, certain rules may be defined for converting between different currencies used by the first performer and the performers.

In addition, the computing device 104a may enable the first performer to select one or more recording parameters before recording the accompanying performance. In one example, the first performer may select at least one microphone and/or at least one camera that may be employed to sense the accompanying performance during recording of the accompanying performance. For example, the accompanying performance may be recorded in stereo and/or an image of the first performer may be recorded in a three-dimensional format using a plurality of cameras, for enabling three-dimensional audio-visual content to be finally generated. In another example, the recording parameters may be indicative of one or more ways in which audio of the accompanying performance and the pre-recorded sessions may be mixed. In yet another example, the recording parameters may include relative audio levels to be set for the accompanying performance and the pre-recorded sessions.

Moreover, the computing device 104a replays the pre-recorded sessions whilst substantially temporally simultaneously recording the accompanying performance by the first performer. As described earlier, the pre-recorded sessions may be replayed acoustically and/or visually to the first performer, thereby providing a basis for the accompanying performance.

For example, the pre-recorded sessions may be replayed to help the first performer to perform the accompanying performance substantially in sync with the pre-recorded sessions. It may be noted here that the pre-recorded sessions may be replayed acoustically to the first performer via a headphone attached to the computing device 104 during recording of the accompanying performance, to avoid any acoustic feedback effects.

Optionally, in certain cases where the pre-recorded sessions have been encoded, the replaying of the pre-recorded sessions may also include decoding of the pre-recorded sessions before visually and acoustically replaying the pre-recorded sessions to the first performer.

In accordance with an embodiment of the present disclosure, the pre-recorded sessions are stored locally, for example, in data memory or an internal storage of the computing device 104a, and the replaying of the pre-recorded sessions is thereafter implemented during the recording of the accompanying performance by accessing the pre-recorded sessions stored locally on the computing device 104a.

In accordance with another embodiment of the present disclosure, the pre-recorded sessions are streamed and replayed in real-time by the computing device 104a during the recording of the accompanying performance. Optionally, to least a portion of the accompanying performance may be streamed in real-time back to the server arrangement 102 during the recording thereof.

Moreover, the system 100 renders at least one pre-recorded session from the pre-recorded sessions and the accompanying performance mutually synchronized therewith. For example, the computing device 104a may allow the first performer to select the at least one pre-recorded session to be rendered with the accompanying performance.

Beneficially, the system 100 may render the at least one pre-recorded session and the accompanying performance as a mosaic of images and/or videos on the GUI presented on the display screens of the computing device 104a.

For example, the computing device 104a may render the at least one pre-recorded session and the accompanying performance, after recording the accompanying performance. This may allow the first performer to check whether he/she is satisfied with his/her recorded accompanying performance. If the first performer is not satisfied with his/her recorded accompanying performance, he/she may choose to record and render his/her accompanying performance again.

Moreover, the mosaic of images and/or videos may be rendered manually or automatically in a predefined format. The predefined format may depend on, for example, a number of the at least one pre-recorded session and the accompanying performance to be rendered, a type of the computing device 104a, and/or one or more preferences of the first performer.

In one example, an image and/or a video of the accompanying performance may be displayed at a central position, while images and/or videos of the at least one pre-recorded session may be displayed at peripheral positions on the GUI. In another example, images and/or videos of the at least one pre-recorded session and the accompanying performance may be displayed randomly at various positions on the GUI. In yet another example, relative sizes, shapes and positions of the images and/or the videos of the at least one pre-recorded session and the accompanying performance may be varied, for example, based on the preferences of the first performer. In still another example, the images and/or the videos of the at least one pre-recorded session and the accompanying performance may be rendered in a grid displayed on the GUI.

Optionally, the mosaic of images and/or videos may be rendered locally on the computing device 104a. Alternatively, the mosaic of images and/or videos may be rendered, at least in part, remotely on the server arrangement 102, wherefrom the mosaic of images and/or videos may be streamed to the computing device 104a in real-time.

Beneficially, the system 100 may automatically choose a location from where the mosaic of images and/or videos may be rendered, for example, depending on a communication characteristic of the communication network 106 coupling the computing device 104a to the server arrangement 102.

Moreover, the system 100 may provide for mutual temporal synchronization of the accompanying performance with the at least one pre-recorded session.

Optionally, the system 100 may render the at least one pre-recorded session and the accompanying performance whilst substantially simultaneously providing for the mutual temporal synchronization of the accompanying performance with the at least one pre-recorded session. For example, the accompanying performance may be mutually temporally synchronized with the at least one pre-recorded session before being uploaded to the server arrangement 102.

The mutual temporal synchronization may be implemented by at least one of:

(i) a tool of the computing device 104a which allows for manual adjustment of relative rendering time of the at least one pre-recorded session with the accompanying performance; and/or
(ii) a tool of the computing device 104a and/or the server arrangement 102 which automatically adjusts the mutual temporal synchronization depending upon information included in the at least one pre-recorded session and/or the accompanying performance, and/or the communication characteristic of the communication network 106 coupling the computing device 104a to the server arrangement 102.

For example, the information included in the at least one pre-recorded session and/or the accompanying performance may be indicative of a temporal offset with which the mutual temporal synchronization may be adjusted. The temporal offset may be either fixed or variable.

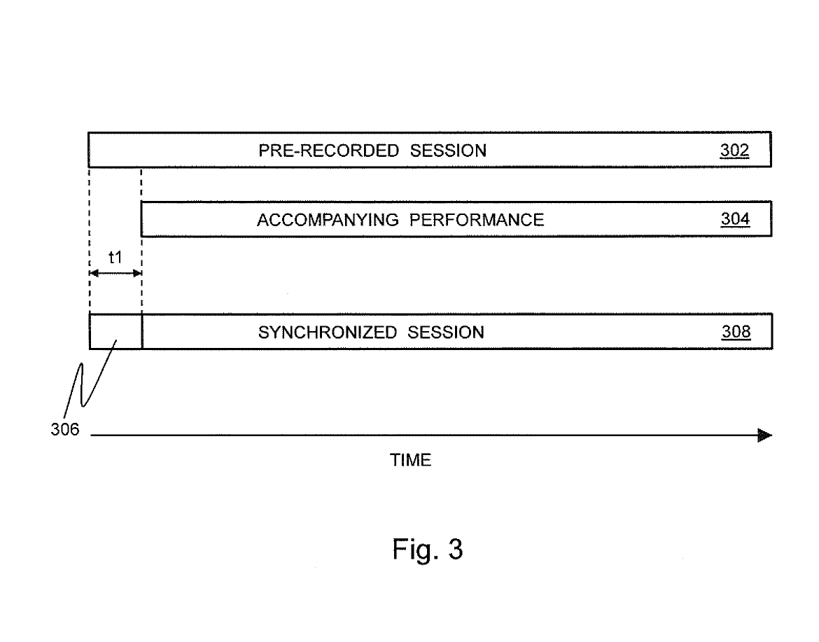

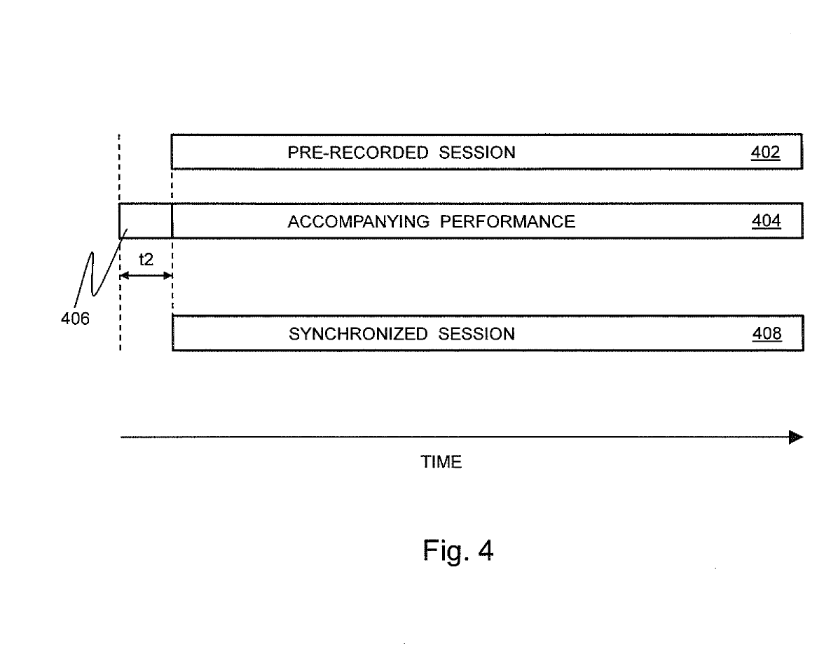

Optionally, the temporal offset may be determined automatically, for example, based on one or more characteristics of the at least one pre-recorded session and the accompanying performance, and/or hardware configuration of the computing device 104a. In one example, the temporal offset may be determined automatically by comparing a time at which the replay of the pre-recorded sessions started with a time at which the recording of the accompanying performance started. In another example, when the temporal offset is determined automatically, a sudden change in audio amplitude and/or a sudden change in visual information can be used as an indication of a given point in time when a performance effectively starts. Optionally, such automatic determination of the temporal offset involves determining a rhythm or beat signature present in the at least one pre-recorded session and/or the accompanying performance, for example, determined by identifying temporally repetitive reoccurrence of harmonic components via Fast Fourier Transform (FFT) analysis. However, other approaches for determining the temporal offset automatically may be employed. Details of how the temporal offset may be employed have been provided in conjunction with FIGS. 3 and 4.

In addition, the communication characteristic of the communication network 106 may, for example, include at least one of:

(a) a communication rate achievable between the computing device 104a and the server arrangement 102,
(b) a cost of communication between the computing device 104a and the server arrangement 102, and/or
(c) a Quality-of-Service (QoS) of communication.

In one example, the tool of the computing device 104a may automatically adjust the mutual temporal synchronization locally to avoid latency and interruption via the communication network 106, for example, when the communication rate achievable between the computing device 104a and the server arrangement 102 is below a threshold value.

In another example, the tool of the computing device 104a may automatically adjust the mutual temporal synchronization locally to minimize the cost of communication.

In yet another example, the tool of the server arrangement 102 may automatically adjust the mutual temporal synchronization, for example, when the communication rate and/or the QoS of communication are satisfactorily high with negligible probability that latency and interruption may occur.

Optionally, the computing device 104a may encode the recorded accompanying performance as per a suitable compression format. The compression format may either be selected by the first performer or be system-defined by default. The compression format may, for example, be either lossless or lossy.

Subsequently, the system 100 may enable the first performer to upload his/her recorded accompanying performance to the server arrangement 102. The recorded accompanying performance may be uploaded in a form of a composite session that includes the recorded accompanying performance substantially temporally synchronized with at least one of the pre-recorded sessions.

In order to create the composite session, the first performer may select the at least one of the pre-recorded sessions with which the accompanying performance is to be temporally synchronized, for example, using the GUI. Optionally, the composite session may include a mosaic of images and/or videos of the accompanying performance and the at least one of the pre-recorded sessions.

Alternatively, the recorded accompanying performance may be uploaded as a separate session in a non-synchronized form. In such a case, the first performer and/or a tool of the computing device 104a may optionally include information about how the accompanying performance may be synchronized with one or more of the pre-recorded sessions in a manual, semi-automatic or automatic manner.

Beneficially, the accompanying performance may be uploaded along with information pertaining to the first performer and/or the accompanying performance, for example, including at least one of: an identification code (ID) associated with the first performer, a name of the first performer, a place where the accompanying performance was recorded, a duration of the accompanying performance, and/or a date or time when the accompanying performance was recorded.

The recorded accompanying performance may be uploaded to the server arrangement 102, for example, for subsequent distribution to other computing devices. Beneficially, at least one of the databases 108 may be used to store the accompanying performance uploaded by the first performer.

Optionally, subsequent distribution of one or more sessions including the accompanying performance may be subject to financial payment to at least one of: the first performer associated with the accompanying performance, and/or the performers responsible for creating the pre-recorded sessions.

Accordingly, the system 100 may enable the first performer to manage use of his/her accompanying performance. For example, the first performer may provide information including at least one of: who may be allowed to use his/her accompanying performance, territories and/or countries where his/her accompanying performance may be used and/or distributed, how his/her accompanying performance may be used, a number of times his/her accompanying performance may be used, a time period for which his/her accompanying performance may be used, an amount that may be charged for use of his/her accompanying performance, one or more modes in which the amount may be paid, and/or how the amount may be shared amongst one or more performers whose accompanying performances have been used along with his/her accompanying performance.

The information provided by the first performer may then be uploaded to the server arrangement 102 along with the accompanying performance. Beneficially, the information provided by the first performer may be stored in at least one of the databases 108.

In one example, the accompanying performance may be distributed to users, who wish to create a single composite session from the accompanying performance and one or more pre-recorded sessions available via the server arrangement 102. Let us consider, for example, that a given user associated with a given computing device wishes to create a single composite session that includes the accompanying performance.

Accordingly, the given user may select the accompanying performance and one or more pre-recorded sessions related to the accompanying performance to be included in the composite session. The given computing device may then receive the accompanying performance and the pre-recorded sessions from the server arrangement 102. Optionally, the server arrangement 102 may allow download of a limited number of the pre-recorded sessions.

The given computing device may then mutually temporally synchronize the accompanying performance and the pre-recorded sessions, and render the accompanying performance and the pre-recorded sessions as a mosaic of images and/or videos, as described earlier.

Subsequently, the given computing device may create the composite session and include the mosaic of images and/or videos as a part of the composite session. The given user may then upload the composite session to the server arrangement 102. Beneficially, the uploaded composite session may be stored in at least one of the databases 108.

In another example, the accompanying performance may be distributed to interested performers, who wish to create additional accompanying performances for the particular song related to the accompanying performance by the first performer.

In yet another example, the first performer may invite one or more interested performers to create additional accompanying performances. For this purpose, the first performer may send an invite to the interested performers by using electronic mails or a social networking service provided by the server arrangement 102. In order to implement the social networking service, information about various performers may be stored in at least one of the databases 108. For example, information about a particular performer may include at least one of: an ID associated with that particular performer, a profile of that particular performer, and/or one or more accompanying performances created by that particular performer.

Continuing from the previous example scenario, let us consider that the second performer and the third performer associated with the computing device 104b wish to create an additional accompanying performance for the particular song. Accordingly, the computing device 104b may receive the accompanying performance and/or one or more of the pre-recorded sessions related to that particular song.

Optionally, receiving of the accompanying performance and/or the pre-recorded sessions from the server arrangement 102 may be subject to financial payment to at least one of: the first performer associated with the accompanying performance, and/or the performers responsible for creating the pre-recorded sessions. For this purpose, the second performer and the third performer may have one or more pre-paid accounts from which the financial payment may be made, for example, to the pre-paid account of the first performer and/or pre-paid accounts of the performers responsible for creating the pre-recorded sessions.

Consequently, the computing device 104b may replay the accompanying performance and/or the pre-recorded sessions whilst substantially temporally simultaneously recording the additional accompanying performance by the second performer and the third performer, as described earlier.

In addition, the computing device 104b may provide for mutual temporal synchronization of the additional accompanying performance with the accompanying performance and/or the pre-recorded sessions, as described earlier.

Moreover, the computing device 104b may enable the second performer and the third performer to upload their recorded additional accompanying performance to the server arrangement 102. For example, the recorded additional accompanying performance may be uploaded in a form of a composite session that includes the recorded additional accompanying performance substantially temporally synchronized with the accompanying performance and/or at least one of the pre-recorded sessions.

For example, the computing device 104b may render the recorded additional accompanying performance and/or the accompanying performance and/or the at least one of the pre-recorded sessions as a mosaic of images and/or videos, based on a selection made by the second performer and the third performer. The second performer and the third performer may then choose to save the rendered mosaic in the form of the composite session. In this manner, the system 100 may provide for generation of audio-visual content for distribution via the server arrangement 102.

Furthermore, the system 100 may enable a performer to create an entirely new session that may be uploaded to the server arrangement 102 for subsequent distribution to other interested performers. The new session may then be available to the other interested performers as a pre-recorded session, which may provide a basis for various accompanying performances by the other interested performers.

Moreover, the system 100 may collect statistical information pertaining to generation and/or distribution and/or sales of pre-recorded sessions and their corresponding accompanying performances. Additionally, the system 100 may analyze the statistical information to provide one or more reports, for example, based on songs, performers, amounts charged, and/or countries. Such reports may be able, for example, to highlight new talented musicians, as well as providing an analysis of changes in musical taste and aspirations, namely, important information for commercial organisations promoting and selling audio-visual content generally. Optionally, the reports may be sold in return for payment.

It should be noted here that the implementation of the system 100 is not limited to a specific type or number of server arrangements, computing devices, communication networks, and databases. FIG. 1 is merely an example, which should not unduly limit the scope of the claims herein. One of ordinary skill in the art would recognize many variations, alternatives, and modifications of embodiments herein.

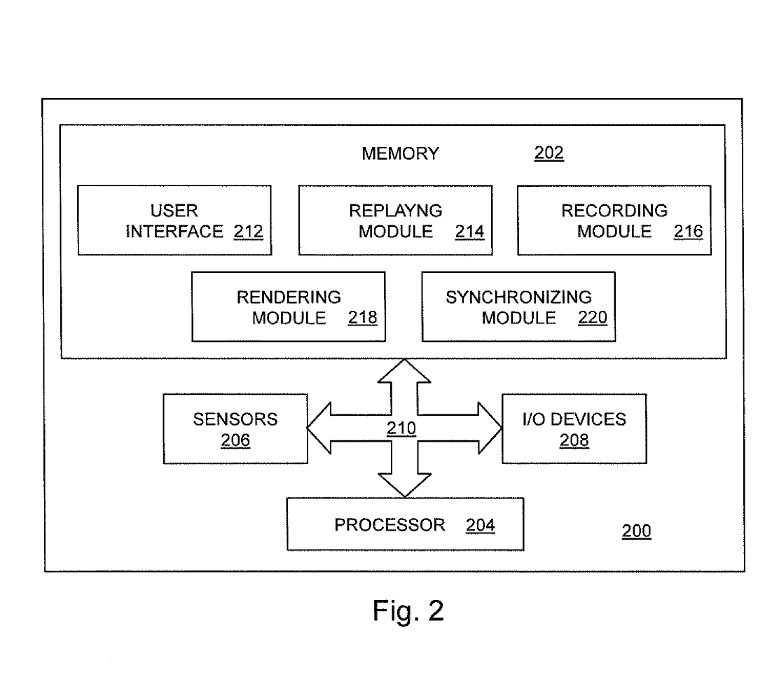

FIG. 2 is a schematic illustration of various components in an example implementation of a given computing device 200, in accordance with an embodiment of the present disclosure. The given computing device 200 may, for example, be a computing device from amongst the computing devices 104.

The given computing device 200 includes, but is not limited to, a memory 202, a processor 204, a configuration of sensors 206, Input/Output (I/O) devices 208, and a system bus 210 that operatively couples various components including the memory 202, the processor 204, the sensors 206 and the I/O devices 208. The memory 202 stores a user interface 212, a replaying module 214, a recording module 216, a rendering module 218, and a synchronizing module 220.

The sensors 206 may, for example, include one or more image sensors and/or one or more audio sensors for sensing an accompanying performance by at least one performer associated with the given computing device 200. The image sensors may be operable to sense visually the accompanying performance, and capture images and/or videos of the accompanying performance by the at least one performer. The audio sensors may be operable to sense acoustically the accompanying performance, and capture audio of the accompanying performance by the at least one performer. For example, the image sensors and the audio sensors may be implemented as at least one camera and at least one microphone of the given computing device 200, respectively.

Beneficially, the recording module 216 may be interfaced with the sensors 206. When executed on the processor 204, the recording module 216 employs the at least one camera and/or the at least one microphone of the given computing device 200, to record the accompanying performance by the at least one performer.

When executed on the processor 204, the user interface 212 provides for one or more options to the at least one performer associated with the given computing device 200. For example, the at least one performer may be provided an option to browse through a list of pre-recorded sessions related to one or more songs available via the server arrangement 102. Alternatively or additionally, the at least one performer may be provided an option to search for one or more pre-recorded sessions related to a particular song available via the server arrangement 102.

Beneficially, the user interface 212 may be in a form of a GUI presented on one or more display screens of the given computing device 200.

In addition, the user interface 212 may allow the at least one performer to make a selection of one or more pre-recorded sessions to be received at the given computing device 200. Based upon the selection made by the at least one performer, the given computing device 200 may then receive the pre-recorded sessions from the server arrangement 102.

When executed on the processor 204, the replaying module 214 replays the pre-recorded sessions, whilst substantially temporally simultaneously the recording module 216 records the accompanying performance by the at least one performer. As described earlier, the pre-recorded sessions may be replayed acoustically and/or visually to the at least one performer.

In accordance with an embodiment of the present disclosure, the pre-recorded sessions are stored in the memory 202 of the given computing device 200, and the replaying of the pre-recorded sessions is thereafter implemented during the recording of the accompanying performance by accessing the pre-recorded sessions stored in the memory 202 of the given computing device 200. In accordance with another embodiment of the present disclosure, one or more of the pre-recorded sessions are streamed and replayed in real-time by the given computing device 200 during the recording of the accompanying performance.

Moreover, the user interface 212 may allow the at least one performer to make a selection of at least one pre-recorded session from the pre-recorded sessions to be rendered with the accompanying performance. When executed on the processor 204, the rendering module 218 renders the at least one pre-recorded session and the accompanying performance mutually synchronized therewith.

For example, the rendering module 218 may render the at least one pre-recorded session and the accompanying performance, after the recording module 216 has recorded the accompanying performance. In this way, the rendering module 218 may allow the at least one performer to check whether he/she is satisfied with his/her recorded accompanying performance. The at least one performer may choose to record repeatedly and render his/her accompanying performance until he/she is satisfied with his/her accompanying performance.

Beneficially, the rendering module 218 may render the at least one pre-recorded session and the accompanying performance as a mosaic of images and/or videos on the GUI presented on the display screens of the given computing device 200.

Moreover, the rendering module 218 may render the mosaic of images and/or videos in a predefined format depending on, for example, a number of the at least one pre-recorded session and the accompanying performance to be rendered, a type of the given computing device 200, and/or one or more preferences of the at least one performer, as described earlier. Examples of the type of the given computing device 200 include, but are not limited to, a mobile phone, a smart phone, an MID, a tablet computer, a UMPC, a phablet, a PDA, a web pad, a PC, a handheld PC, a laptop computer, and an interactive entertainment computer.

When executed on the processor 204, the synchronizing module 220 provides for mutual temporal synchronization of the accompanying performance with the at least one pre-recorded session. Optionally, the rendering module 218 renders the at least one pre-recorded session and the accompanying performance, whilst substantially simultaneously the synchronizing module 220 provides for the mutual temporal synchronization of the accompanying performance with the at least one pre-recorded session.

Beneficially, the synchronizing module 220 may allow for manual adjustment of relative rendering time of the at least one pre-recorded session with the accompanying performance. Alternatively or additionally, the synchronizing module 220 may automatically adjust the mutual temporal synchronization, as described earlier.

Once the accompanying performance is recorded, the given computing device 200 may be operable to enable the at least one performer to upload their recorded accompanying performance to the server arrangement 102. As described earlier, the recorded accompanying performance may be uploaded in a form of a composite session that includes the recorded accompanying performance substantially temporally synchronized with at least one of the pre-recorded sessions.

In order to create the composite session, the at least one performer may select the at least one of the pre-recorded sessions with which the accompanying performance is to be temporally synchronized, for example, using the GUI. Optionally, the composite session may include a mosaic of images and/or videos of the accompanying performance and the at least one of the pre-recorded sessions, for example, as rendered by the rendering module 218.

The recorded accompanying performance may be uploaded to the server arrangement 102, for example, for subsequent distribution to other computing devices, as described earlier.

FIG. 2 is merely an example, which should not unduly limit the scope of the claims herein. It is to be understood that the specific designation for the given computing device 200 is for the convenience of reader and is not to be construed as limiting the given computing device 200 to specific numbers, types, or arrangements of modules and/or components of the given computing device 200. One of ordinary skill in the art would recognize many variations, alternatives, and modifications of embodiments of the present disclosure.

For example, the computing devices 104 could be implemented in a manner similar to the example implementation of the given computing device 200.

FIG. 3 is an illustration of the mutual temporal synchronization in a first example scenario, in accordance with an embodiment of the present disclosure. In the first example scenario, a pre-recorded session 302 and an accompanying performance 304 are to be mutually temporally synchronized.

In the first example scenario, the pre-recorded session 302 is substantially temporally longer than the accompanying performance 304, as shown in FIG. 3. In one example, the pre-recorded session 302 may be longer than the accompanying performance 304, in a case where the accompanying performance 304 may be rendered with only a portion of the pre-recorded session 302. In another example, the pre-recorded session 302 may be longer than the accompanying performance 304, in a case where recording of the accompanying performance 304 starts after replaying of pre-recorded session 302 has started.

Accordingly, a temporal offset (t1) between the pre-recorded session 302 and the accompanying performance 304 may be determined automatically. The temporal offset (t1) may be determined automatically, for example, based on one or more characteristics, such as amplitude of audio signals and/or harmonic content of audio signals, of the pre-recorded session 302 and the accompanying performance 304, and/or hardware configuration of computing devices on which the pre-recorded session 302 and the accompanying performance 304 have been recorded.

In one example, the temporal offset (t1) may be determined automatically by comparing a time at which the replay of the pre-recorded session 302 started with a time at which the recording of the accompanying performance 304 started. In another example, a sudden change in audio amplitude and/or a sudden change in visual information can be used as an indication of a given point in time when the pre-recorded session 302 and/or the accompanying performance 304 effectively start. Optionally, such automatic determination of the temporal offset (t1) involves determining a rhythm or beat signature present in the pre-recorded session 302 and/or the accompanying performance 304, for example, determined by identifying temporally repetitive reoccurrence of harmonic components via FFT analysis.

Alternatively, the temporal offset (t1) may be provided manually by one or more performers responsible for creating the pre-recorded session 302 and/or the accompanying performance 304.

Thereafter, the temporal offset (t1) may be employed to temporally insert a blank session 306 before the accompanying performance 304, to generate a synchronized session 308, as shown in FIG. 3. Alternatively, the temporal offset (t1) may be employed to temporally shift the accompanying performance 304 relative to the pre-recorded session 302, to generate the synchronized session 308. Beneficially, such insertion or temporal shifting may be performed after or during mutual temporal synchronization.

Accordingly, the synchronized session 308 may be of a length that is substantially equal to a length of the pre-recorded session 302, i.e., the longest amongst the pre-recorded session 302 and the accompanying performance 304.

Beneficially, the synchronized session 308 may be in a form of a composite session that may include the pre-recorded session 302 and the accompanying performance 304 mutually temporally synchronized therewith.

In this manner, the mutual temporal synchronization ensures that the accompanying performance 304 is rendered in sync with the pre-recorded session 302.

FIG. 3 is merely an example, which should not unduly limit the scope of the claims herein. One of ordinary skill in the art would recognize many variations, alternatives, and modifications of embodiments herein. For example, the pre-recorded session 302 may be longer than the accompanying performance 304, in a case where the recording of the accompanying performance 304 stops before the replaying of pre-recorded session 302 has stopped. In such a case, a suitable temporal offset may be determined and employed to temporally insert a blank session after the accompanying performance 304, or temporally shift the accompanying performance 304 relative to the pre-recorded session 302, as required.

FIG. 4 is an illustration of the mutual temporal synchronization in a second example scenario, in accordance with an embodiment of the present disclosure. In the second example scenario, a pre-recorded session 402 and an accompanying performance 404 are to be mutually temporally synchronized.

In the second example scenario, the accompanying performance 404 is substantially temporally longer than the pre-recorded session 402, as shown in FIG. 4. For example, the accompanying performance 404 may be longer than the pre-recorded session 402, in a case where recording of the accompanying performance 404 starts before replaying of pre-recorded session 402 has started.

Accordingly, a temporal offset (t2) between the pre-recorded session 402 and the accompanying performance 404 may be determined automatically, for example, based on one or more characteristics of the pre-recorded session 402 and the accompanying performance 404, and/or hardware configuration of computing devices on which the pre-recorded session 402 and the accompanying performance 404 have been recorded.

In one example, the temporal offset (t2) may be determined automatically by comparing a time at which the replay of the pre-recorded session 402 started with a time at which the recording of the accompanying performance 404 started. In another example, a sudden change in audio amplitude and/or a sudden change in visual information can be used as an indication of a given point in time when the pre-recorded session 402 and/or the accompanying performance 404 effectively start. Optionally, such automatic determination of the temporal offset (t2) involves determining a rhythm or beat signature present in the pre-recorded session 402 and/or the accompanying performance 404, for example, determined by identifying temporally repetitive reoccurrence of harmonic components via FFT analysis.

Consequently, the temporal offset (t2) may be employed to temporally truncate a portion 406 of the accompanying performance 404, to generate a synchronized session 408, as shown in FIG. 4. Beneficially, such truncation may be performed after or during mutual temporal synchronization. Accordingly, the synchronized session 408 may be of a length that is substantially equal to a length of the pre-recorded session 402.

Beneficially, the synchronized session 408 may be in a form of a composite session that may include the pre-recorded session 402 and the truncated accompanying performance 404 mutually temporally synchronized therewith.

Alternatively, the temporal offset (t2) may be employed to temporally insert a blank session before the pre-recorded session 402, for example, depending on one or more preferences of one or more performers responsible for creating the pre-recorded session 402 and/or the accompanying performance 404. Beneficially, such insertion may be performed after or during mutual temporal synchronization. Accordingly, the synchronized session 408 may be of a length that is substantially equal to a length of the accompanying performance 404, i.e., the longest amongst the pre-recorded session 402 and the accompanying performance 404.

Yet alternatively, the temporal offset (t2) may be employed to temporally shift the accompanying performance 404 relative to the pre-recorded session 402, such that the synchronized session 408 may be of a length that is substantially equal to the length of the accompanying performance 404. Beneficially, such temporal shifting may be performed after or during mutual temporal synchronization.

In this manner, the mutual temporal synchronization ensures that the accompanying performance 404 is rendered in sync with the pre-recorded session 402.

FIG. 4 is merely an example, which should not unduly limit the scope of the claims herein. One of ordinary skill in the art would recognize many variations, alternatives, and modifications of embodiments herein. For example, the accompanying performance 404 may be longer than the pre-recorded session 402, in a case where the recording of the accompanying performance 404 stops after the replaying of pre-recorded session 402 has stopped. In such a case, a suitable temporal offset may be determined and employed to temporally truncate the accompanying performance 404 or temporally insert a blank session after the pre-recorded session 402, or temporally shift the accompanying performance 404 relative to the pre-recorded session 402, as required.

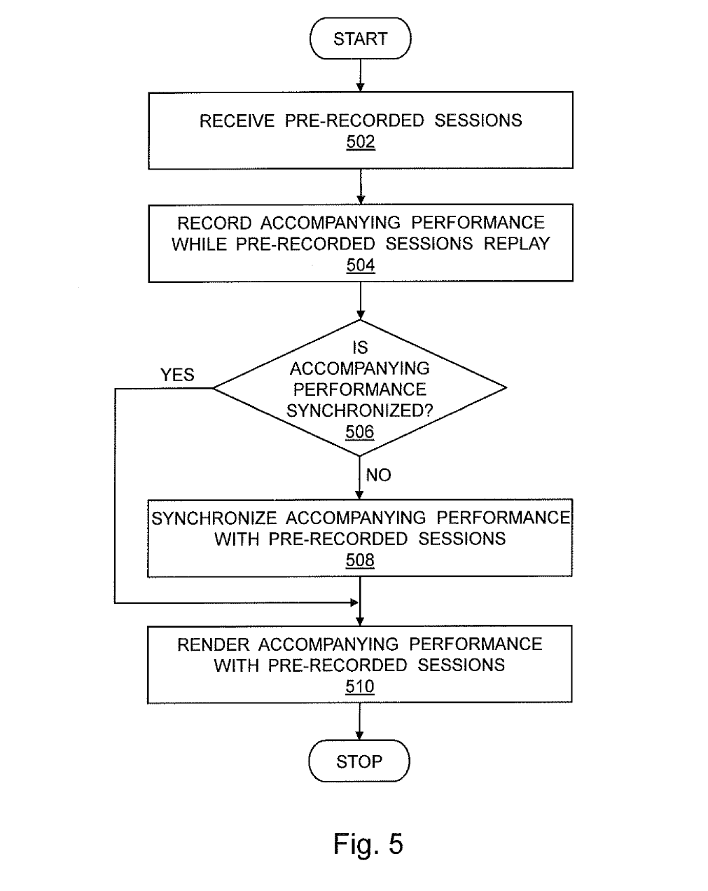

FIG. 5 is an illustration of steps of a method of using the system 100 to provide the environment in which one or more performers are able to generate one or more corresponding performances which are mutually synchronized irrespective of location globally, in accordance with an embodiment of the present disclosure. The method is depicted as a collection of steps in a logical flow diagram, which represents a sequence of steps that can be implemented in hardware, software, or a combination thereof.

For illustration purposes, let us consider the previous example scenario in which the first performer associated with the computing device 104a wishes to create an accompanying performance related to a particular song. Accordingly, at a step 502, one or more pre-recorded sessions related to that particular song are received from the server arrangement 102. The step 502 may be performed, for example, based upon a selection made by the first performer.

Next, at a step 504, the pre-recorded sessions are replayed acoustically and/or visually to the first performer, while substantially temporally simultaneously the accompanying performance by the first performer is recorded.

Subsequently, at a step 506, it is checked whether or not the accompanying performance is mutually synchronized with the pre-recorded sessions. If, at the step 506, it is found that the accompanying performance is not mutually synchronized with the pre-recorded sessions, a step 508 is performed. If, at the step 506, it is found that the accompanying performance is mutually synchronized with the pre-recorded sessions, a step 510 is performed.

At the step 508, the accompanying performance is mutually temporally synchronized with at least one of the pre-recorded sessions, as described earlier. For example, a suitable temporal offset may be employed to mutually temporally synchronize the accompanying performance with the at least one of the pre-recorded sessions.

Optionally, the steps 506 and 508 may be performed substantially simultaneously with the step 504.

At the step 510, the accompanying performance and the at least one of the pre-recorded sessions are rendered as a mosaic of images and/or videos, as described earlier.

Optionally, the step 510 may be performed substantially simultaneously with the step 508.

Additionally, the method may include a step at which the mosaic of images and/or videos rendered at the step 510 may be saved as a composite session.

Optionally, the method may include a step at which the composite session may be uploaded to the server arrangement 102, for example, for subsequent distribution to interested performers. Additionally or alternatively, the method may include a step at which the accompanying performance alone may be uploaded to the server arrangement 102.

It should be noted here that the steps 502 to 510 are only illustrative and other alternatives can also be provided where one or more steps are added, one or more steps are removed, or one or more steps are provided in a different sequence without departing from the scope of the claims herein.

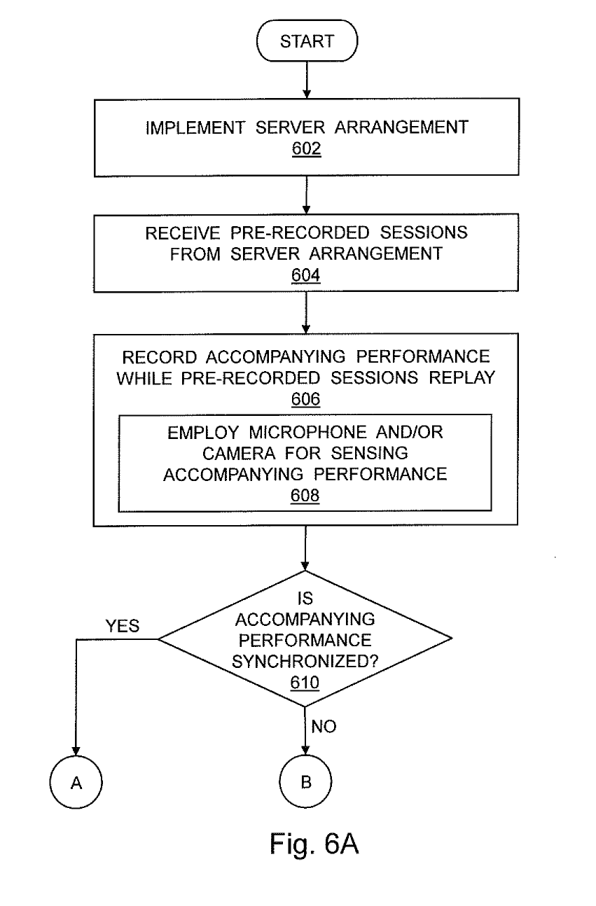

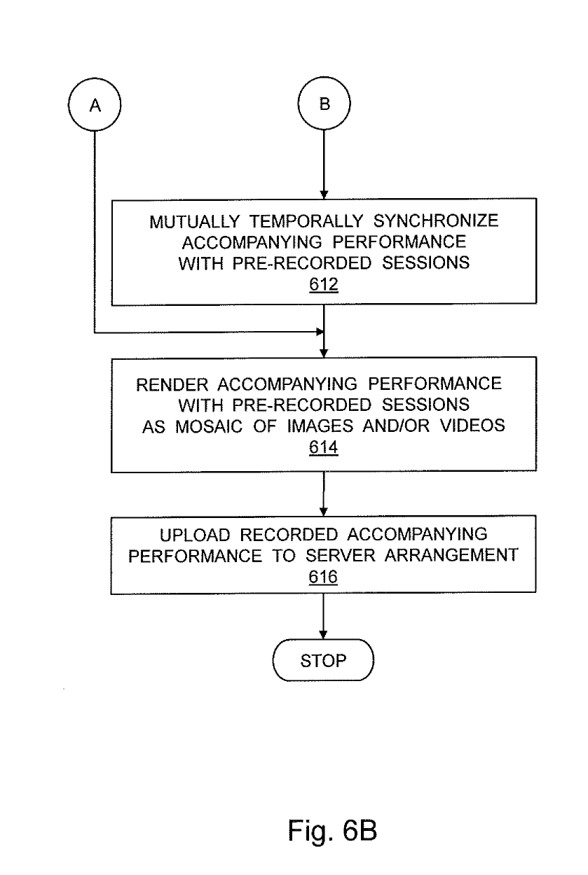

FIGS. 6A and 6B are illustrations of steps of a detailed method of using the system 100 to provide the environment in which the performers are able to generate the corresponding performances which are mutually synchronized irrespective of location globally, in accordance with an embodiment of the present disclosure. The detailed method is depicted as a collection of steps in a logical flow diagram, which represents a sequence of steps that can be implemented in hardware, software, or a combination thereof.

At a step 602, the server arrangement 102 is implemented. Optionally, the server arrangement 102 may be implemented, at least in part, in the computing devices 104. Alternatively, the server arrangement 102 may be implemented spatially remotely from the computing devices 104.

Additionally, the databases 108 associated with the server arrangement 102 may also be implemented at the step 602.

For illustration purposes, let us consider the previous example scenario in which the first performer associated with the computing device 104a wishes to create an accompanying performance related to a particular song. The first performer may browse through and/or search for one or more pre-recorded sessions related to that particular song available via the server arrangement 102. Accordingly, at a step 604, one or more of the pre-recorded sessions are received from the server arrangement 102, for example, based upon a selection made by the first performer.

Optionally, receiving of the pre-recorded sessions from the server arrangement 102 at the step 604 may be subject to financial payment to one or more performers responsible for creating the pre-recorded sessions.

Next, at a step 606, the pre-recorded sessions are replayed acoustically and/or visually to the first performer, while substantially temporally simultaneously the accompanying performance by the first performer is recorded.

In accordance with an embodiment of the present disclosure, the pre-recorded sessions are stored locally on the computing device 104a after being received at the step 604, and thereafter, the replaying of the pre-recorded sessions at the step 606 is implemented by accessing the pre-recorded sessions stored locally on the computing device 104a.

In accordance with another embodiment of the present disclosure, the pre-recorded sessions are streamed and replayed in real-time, simultaneously at the steps 604 and 606, respectively.

In addition, the step 606 includes a step 608 at which at least one microphone and/or at least one camera of the computing device 104a is employed for sensing the accompanying performance, as described earlier.

Subsequently, at a step 610, it is checked whether or not the accompanying performance is mutually temporally synchronized with the pre-recorded sessions. If, at the step 610, it is found that the accompanying performance is not mutually temporally synchronized with the pre-recorded sessions, a step 612 is performed. Otherwise, if, at the step 610, it is found that the accompanying performance is mutually temporally synchronized with the pre-recorded sessions, a step 614 is performed.

At the step 612, the accompanying performance is mutually temporally synchronized with at least one of the pre-recorded sessions, as described earlier. For example, a suitable temporal offset may be employed to mutually temporally synchronize the accompanying performance with the at least one of the pre-recorded sessions, as described in FIGS. 3 and 4.

Optionally, the step 612 may be implemented by a tool of the computing device 104a, which allows for manual adjustment of relative rendering time of the at least one of the pre-recorded sessions with the accompanying performance. Alternatively or additionally, the step 612 may be implemented automatically by a tool of the computing device 104a and/or the server arrangement 102, as described earlier.

Beneficially, the steps 610 and 612 may be performed substantially simultaneously with the step 606.

At the step 614, the accompanying performance and the at least one of the pre-recorded sessions are rendered, as described earlier. Beneficially, the accompanying performance and the at least one of the pre-recorded sessions may be rendered as a mosaic of images and/or videos on the GUI presented on the display screens of the computing device 104a, as described earlier.

In addition, the step 614 may include one or more additional steps at which a predefined format may be selected for rendering the mosaic of images and/or videos, for example, depending on a number of the at least one of the pre-recorded sessions and the accompanying performance to be rendered, a type of the computing device 104a, and/or one or more preferences of the first performer. Consequently, the mosaic of images and/or videos may be rendered in the predefined format.

Optionally, the step 614 may be performed substantially simultaneously with the step 612.

Further, the first performer may choose to repeatedly perform the steps 606 to 614 until he/she is satisfied with his/her accompanying performance.

Additionally, the method may include a step at which the mosaic of images and/or videos rendered at the step 614 may be saved as a composite session.

Subsequently, at the step 616, the accompanying performance is uploaded to the server arrangement 102, for example, for subsequent distribution to interested performers.

Optionally, at the step 616, the composite session, including the mosaic of images and/or videos rendered at the step 614, may be uploaded to the server arrangement 102. Additionally or alternatively, at the step 616, the accompanying performance alone may be uploaded to the server arrangement 102.

Optionally, subsequent distribution of one or more sessions including the accompanying performance may be subject to financial payment to at least one of: the first performer associated with the accompanying performance, and/or the performers responsible for creating the pre-recorded sessions.

It should be noted here that the steps 602 to 616 are only illustrative and other alternatives can also be provided where one or more steps are added, one or more steps are removed, or one or more steps are provided in a different sequence without departing from the scope of the claims herein.

Embodiments of the present disclosure can be used for various purposes, including, though not limited to, enabling users to generate a single composite session from one or more pre-recorded sessions and one or more accompanying performances created separated in distance and time, and to render the composite session as a mosaic of images and/or videos; facilitating automatic synchronization of the pre-recorded sessions and the accompanying performances, thereby enabling amateurs and non-technical users to easily generate audio-visual content; enabling performers to interact and collaborate cost effectively with other performers and users, and to monetize their performances; and enabling entities, such as artists, artist managers, music publishers, music producers, record labels, and media production companies, to develop talent in a collaborative environment. Optionally, embodiments of the present disclosure may be employed for remote musical teaching purposes, wherein a parallel communication pathway may be provided from a teacher to one or more students who may be simultaneously able to employ the system as aforementioned. Such an arrangement may enable the teacher to advise the students in an interactive manner, as they record their performances in respect of a pre-recorded session, for example, generated by the teacher for teaching purposes.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

We claim:

1. A system for providing an environment in which one or more performers are able to generate one or more corresponding performances which are mutually synchronized, wherein the system includes a server arrangement coupled via one or more communication networks to one or more computing devices of the one or more performers,
wherein a given computing device is operable to receive one or more pre-recorded sessions from the server arrangement, and to replay the one or more pre-recorded sessions whilst substantially temporally simultaneously recording an accompanying performance by at least one performer associated with the given computing device, and
wherein the system is operable to render at least one pre-recorded session from the one or more pre-recorded sessions and the accompanying performance mutually synchronized therewith.

2. The system as claimed in claim 1, wherein the system is operable to render the at least one pre-recorded session and the accompanying performance as a mosaic of images and/or videos on a graphical user interface (GUI) presented on one or more display screens of the given computing device.

3. The system as claimed in claim 2, wherein the system is operable to render the mosaic of images and/or videos in a predefined format depending on a number of the at least one pre-recorded session and the accompanying performance to be rendered, a type of the given computing device, and/or one or more preferences of the at least one performer associated with the given computing device.

4. The system as claimed in claim 1, wherein the substantially temporally simultaneous recording employs at least one microphone and/or at least one camera of the given computing device for sensing the accompanying performance.

5. The system as claimed in claim 1, wherein the system is operable to store one or more pre-recorded sessions in data memory of the given computing device, and the replaying of the one or more pre-recorded sessions is thereafter implemented during the recording of the accompanying performance by accessing the one or more pre-recorded sessions stored in the data memory of the given computing device.

6. The system as claimed in claim 1, wherein the system is operable to stream and replay the one or more pre-recorded sessions in real-time by the given computing device during the recording of the accompanying performance.

7. The system as claimed in claim 1, wherein the system is operable to provide for mutual temporal synchronization of the accompanying performance with the at least one pre-recorded session.

8. The system as claimed in claim 7, wherein the system is operable to render the at least one pre-recorded session and the accompanying performance whilst substantially simultaneously providing for the mutual temporal synchronization of the accompanying performance with the at least one pre-recorded session.

9. The system as claimed in claim 7, wherein the mutual temporal synchronization is implemented by at least one of:
(i) a tool of the given computing device which allows for manual adjustment of relative rendering time of the at least one pre-recorded session with the accompanying performance; and/or
(ii) a tool of the given computing device and/or the server arrangement which automatically adjusts the mutual temporal synchronization depending upon information included in the at least one pre-recorded session and/or the accompanying performance, and/or a communication characteristic of the one or more communication networks coupling the given computing device to the server arrangement.

10. The system as claimed in claim 1, wherein the system is operable to enable the at least one performer to upload their recorded accompanying performance to the server arrangement for subsequent distribution to other computing devices therefrom.

11. The system as claimed in claim 10, wherein uploading of the recorded accompanying performance is in a form of a composite session including the recorded accompanying performance substantially temporally synchronized with at least one of the one or more pre-recorded sessions.

12. The system as claimed in claim 1, wherein the server arrangement is, at least in part, implemented in the one or more computing devices.

13. The system as claimed in claim 1, wherein the server arrangement is implemented spatially remotely from the one or more computing devices.

14. The system as claimed in claim 1, wherein the system is operable to provide for generation of audio-visual content for distribution via the server arrangement.

15. The system as claimed in claim 1, wherein receiving of the one or more pre-recorded sessions from the server arrangement, and/or subsequent distribution of one or more sessions including the accompanying performance is subject to financial payment to at least one of: the at least one performer associated with the accompanying performance, and/or one or more performers responsible for creating the one or more pre-recorded sessions.

16. A method of using a system to provide an environment in which one or more performers are able to generate one or more corresponding performances which are mutually synchronized, wherein the system includes a server arrangement coupled via one or more communication networks to one or more computing devices of the one or more performers, wherein the method includes:
(i) operating a given computing device to receive one or more pre-recorded sessions from the server arrangement;
(ii) replaying the one or more pre-recorded sessions whilst substantially temporally simultaneously recording an accompanying performance by at least one performer associated with the given computing device; and
(iii) rendering at least one pre-recorded session from the one or more pre-recorded sessions and the accompanying performance mutually synchronized therewith.

17. The method as claimed in claim 16, wherein the method includes rendering the at least one pre-recorded session and the accompanying performance as a mosaic of images and/or videos on a graphical user interface (GUI) presented on one or more display screens of the given computing device.

18. The method as claimed in claim 17, wherein the method includes rendering the mosaic of images and/or videos in a predefined format depending on a number of the at least one pre-recorded session and the accompanying performance to be rendered, a type of the given computing device, and/or one or more preferences of the at least one performer associated with the given computing device.

19. The method as claimed in claim 16, wherein the method includes employing at least one microphone and/or at least one camera of the given computing device for sensing the accompanying performance.

20. The method as claimed in claim 16, wherein the method includes storing the one or more pre-recorded sessions in data memory of the given computing device, and implementing the replaying of the one or more pre-recorded sessions thereafter during the recording of the accompanying performance by accessing the one or more pre-recorded sessions stored in the data memory of the given computing device.

21. The method as claimed in claim 16, wherein the method includes streaming and replaying the one or more pre-recorded sessions in real-time during the recording of the accompanying performance.

22. The method as claimed in claim 16, wherein the method includes mutually temporally synchronizing the accompanying performance with the at least one pre-recorded session.

23. The method as claimed in claim 22, wherein the method includes implementing the rendering of the at least one pre-recorded session and the accompanying performance whilst substantially simultaneously providing for the mutual temporal synchronization of the accompanying performance with the at least one pre-recorded session.

24. The method as claimed in claim 22, wherein the mutually temporally synchronizing is implemented by at least one of:
(i) a tool of the given computing device which allows for manual adjustment of relative rendering time of the at least one pre-recorded session with the accompanying performance; and/or
(ii) a tool of the given computing device and/or the server arrangement which automatically adjusts the mutual temporal synchronization depending upon information included in the at least one pre-recorded session and/or the accompanying performance, and/or a communication characteristic of the one or more communication networks coupling the given computing device to the server arrangement.

25. The method as claimed in claim 16, wherein the method includes uploading the recorded accompanying performance to the server arrangement for subsequent distribution to other computing devices therefrom.

26. The method as claimed in claim 25, wherein the method includes uploading the recorded accompanying performance in a form of a composite session including the recorded accompanying performance substantially temporally synchronized with at least one of the one or more pre-recorded sessions.

27. The method as claimed in claim 16, wherein the method includes implementing the server arrangement, at least in part, in the one or more computing devices.

28. The method as claimed in claim 16, wherein the method includes implementing the server arrangement spatially remotely from the one or more computing devices.

29. The method as claimed in claim 16, wherein the method includes generating audio-visual content for distribution via the server arrangement.

30. The method as claimed in claim 16, wherein receiving of the one or more pre-recorded sessions from the server arrangement, and/or subsequent distribution of one or more sessions including the accompanying performance is subject to financial payment to at least one of: the at least one performer associated with the accompanying performance, and/or one or more performers responsible for creating the one or more pre-recorded sessions.

31. A software product recorded on non-transitory machine-readable data storage media, wherein the software product is executable upon computing hardware for implementing the method as claimed in claim 16.
